(19) United States
(12) Patent Application Publication
(10) Pub. No.: US 2014/0227629 A1
(43) Pub. Date: Aug. 14, 2014

(54) Half-cell Spacer Material for Enhanced Flow Distribution

(71) Applicant: ZBB Energy Corporation, Menomonee Falls, WI (US)

(72) Inventors: Nathan Coad, Bateman (AU); Peter Lex, Monomonee Falls, WI (US)

(73) Assignee: ZBB Energy Corporation, Menomonee Falls, WI (US)

(21) Appl. No.: 14/182,425

(22) Filed: Feb. 18, 2014

Related U.S. Application Data
(63) Continuation-in-part of application No. 13/591,802, filed on Aug. 22, 2012.
(60) Provisional application No. 61/526,146, filed on Aug. 22, 2011.

(51) Int. Cl. H01M 8/02; H01M 8/18

(52) U.S. Cl. CPC H01M 8/0245; H01M 8/188
USPC 429/514; 429/105

(57) ABSTRACT

Disclosed is method for enhancing electrolyte flowing mechanism within electrodes in flow battery cells by employing half-cell spacer screens that may be welded to at least one surface of each electrode sheet. Half-cell spacer screens may provide a constant gap thickness between electrode sheet and micro-porous separator membrane. Half-cell spacer screens may be made of a bromine inert thermoplastic such as polypropylene or polyethylene and may include at least one thin layer of strands. Additionally, the disclosed half-cell spacer screens may exhibit diamond pattern netting or any other suitable pattern. The inclusion of half-cell spacer screens may allow an improved distribution of electrolyte throughout the surface of electrode sheet, thereby improving performance flow batteries.

### CROSS-REFERENCE RELATED APPLICATIONS

This application claims priority as a continuation-in-part of U.S. Non-Provisional patent application Ser. No. 13/591,802, filed on Aug. 22, 2012, which in turn claims priority from U.S. Provisional Patent Application Ser. No. 61/526,146, filed on Aug. 22, 2011, the entirety of which are each expressly incorporated by reference herein.

### BACKGROUND

1. Field

The present disclosure relates generally to flowing electrolyte battery systems, and more particularly, to electrolyte distribution enhancement within high performance battery cells.

2. Background Information

The performance of electrochemical storage devices involves complex, interrelated physical and chemical processes between electrode materials and electrolytes.

Flowing electrolyte batteries may include stacks of flow frame assemblies. Electrode sheets and separator membranes may be bonded into these flow frames to create electrochemical cells. Flow frames may also include flow channels that may be designed to direct and distribute the electrolyte stream over each electrode. On both sides of each electrode, components of the electrolyte may be deposited and consumed during each cycle. One or both sides of the electrode may include a reaction promoter, such as a carbon sheet or powder, which supports the electrode evolution and consumption reactions.

As such, the battery stacks and electrodes that are currently employed in flow batteries may have several performance and durability limitations. One of the limitations is that battery cells may exhibit a gap between electrode sheets and separator membranes and irregularities in this may affect the electrolyte flow and distribution throughout the battery cell.

In a zinc-bromine flowing electrolyte battery, cell stacks share an aqueous zinc bromide electrolyte and have their own electrodes for deposit and dissolution of elemental zinc during charge and discharge cycles. In this type of battery, electrolyte flow to a cell stack can be inhibited by poorly placed zinc deposits. Additionally, nucleation on odes can cause dendrite formation and branching between electrochemical cells. In either case, the internal resistance of the affected cell stack may be lowered, causing a corresponding drop in the open-circuit voltage across the cell stack.

Differences in open-circuit voltages between cell stacks in flowing electrolyte battery systems can affect charge and discharge cycles of these cell stacks and, potentially, the operation of the battery system. For example, in the aforementioned zinc-bromine battery, a lowered voltage potential in a particular area of a cell within a stack may cause an increase in the rate of zinc accumulation or zinc dendrites localized to that area. This may cause errant operation of the faulty cell such that during operation of the stack, the zinc is continually accumulated and can result in decreased stack performance, leading to irreversible damage and stack failure. Moreover, the additional zinc stored in the faulty cell stack usually comes from a common electrolyte that is normally utilized by neighboring cell stacks. As result of the lowered zinc availability, the energy storage capacity of neighboring cell stacks may also be reduced. Another consequence is that cell stacks having the increased zinc accumulation may not fully deplete the zinc during discharge; eventually resulting in zinc accumulating on electrodes of the faulty cell stack to such an extent that zinc accumulation may cause internal short circuiting between cells of the stack which can potentially destroy the cell stack and possibly, the entire battery system. A further consequence is that the increased zinc accumulation can restrict channels through which the electrolyte flows. Since the electrolyte stream may act to cool the cell stack, the restricted flow may also cause cell stack to overheat and melt critical components. Therefore, zinc dendrites may reduce not only performance of flow batteries but also the operating lifetime of electrochemical cells.

Flowing electrolyte batteries need uniform electrolyte flow rates in each battery cell in order to supply chemicals with an even electrochemical potential inside battery stacks. To achieve a uniform flow rate through each battery cell, flowing electrolyte batteries utilize complex flow distribution zones. However, because electrolytes may have an oily, aqueous and gaseous multiphase nature, and because of structural constraints on the battery cells, uniform flow rates are often not achieved.

For the foregoing reasons, there is a need for materials and method which may provide battery cells with a good electrolyte distribution throughout the surface of electrodes in order to enhance battery longevity and performance.

### BACKGROUND ART

U.S. Pat. No. 8,137,831: la et al., Electrolyte flow configuration for a metal-halogen flow battery (2011 Jun. 27)

Abstract: A flow battery and method of operating a flow battery. The flow battery includes a first electrode, a second electrode and a reaction zone located between the first electrode and the second electrode. The flow battery is configured with a first electrolyte flow configuration in charge mode and a second flow configuration in discharge mode. The first electrolyte flow configuration is at least partially different from the second electrolyte flow configuration.

US20120058370: Kell et al., Flow Battery with Radial Electrolyte Distribution (2010 Aug. 8)

Abstract: An electrochemical flow cell includes a permeable electrode, an impermeable electrode located adjacent to and spaced apart from the permeable electrode and a reaction zone electrolyte flow channel located between a first side of the permeable electrode and a first side of the impermeable electrode. The electrochemical flow cell also includes at least one electrolyte flow channel located adjacent to a second side of the permeable electrode, at least one central electrolyte flow conduit extending through a central portion of the permeable electrode and through a central portion of the impermeable electrode and at least one peripheral electrolyte flow inlet/outlet located in a peripheral portion of the electrochemical cell above or below the permeable electrode.

U.S. Pat. No. 5,366,824: Nozaki et al., Flow battery (1993 Oct. 20)

Abstract: A flow battery comprises a plurality of unit cells each constituted of stacked unit cells each consisting of a prescribed number of stacked diaphragms and positive electrode chambers and negative electrode chambers separated by the diaphragms, a positive electrode fluid tank associated with each unit cell to have its outlet connected with an inlet of the positive electrode chamber of the unit cell and its inlet connected with an outlet of the positive chamber of a immediately preceding unit cell, a negative electrode fluid tank associated with each unit cell to have it outlet connected with an inlet of the negative chamber of the unit cell and its inlet connected with outlet of the negative chamber of an immediately preceding unit cell, a pump for supplying positive electrode fluid from the positive electrode fluid tanks to the positive electrode chambers, a pump for supplying negative electrode fluid from the negative electrode fluid tanks to the negative electrode chambers, and means for electrically connecting the plurality of unit cells in series. The flow battery of this configuration achieves improved charge/discharge coulomb efficiency and voltage efficiency, without reducing pump efficiency, and, by increasing the length, and thus the resistance, of the leakage current path reduces the amount of leakage current.

US20110244277: Gordon II et al, HIGH PERFORMANCE FLOW BATTERY (2011 Mar. 30)

Abstract: High performance flow batteries, based on alkaline zinc/ferro-ferricyanide rechargeable (“ZnFe”) and similar flow batteries, may include one or more of the following improvements. First, the battery design has a cell stack comprising a low resistance positive electrode in at least one positive half-cell and a low resistance negative electrode in at least one negative half-cell, where the positive electrode and negative electrode resistances are selected for uniform high current density across a region of the cell stack. Second, a flow of electrolyte, such as zinc species in the ZnFe battery, with a high level of mixing through at least one negative half-cell in a Zn deposition region proximate a deposition surface where the electrolyte close to the deposition surface has sufficiently high zinc concentration for deposition rates on the deposition surface that sustain the uniform high current density. The mixing in the flow may be induced by structures such as: conductive and non-conductive meshes; screens; ribbons; foam structures; arrays of cones, cylinders, or pyramids; and other arrangements of wires or tubes used solely or in combination with a planar electrode surface. Third, the zinc electrolyte has a high concentration and in some embodiments has a concentration greater than the equilibrium saturation concentration—the zinc electrolyte is super-saturated with Zn ions.

### SUMMARY

The present disclosure includes materials and associated methods for improving electrolyte distribution throughout electrodes by integrating at least one spacer screen in each flow battery half-cell.

The disclosed half-cell spacer screens may be welded to the flow frames or can be inserted in flow battery cells prior to stack assembly. Flow batteries, such as zinc bromine batteries, may use half-cell spacers in order to maintain a constant gap between electrode sheets and micro-porous separator membranes and to prevent the electrode sheet from coming in contact with micro-porous separator membrane. Additionally, half cell spacer screens may provide dimensional stability and improve the electrolyte mixing and flow within the cell.

The disclosed half-cell spacer screens may include at least one bi-planar mesh that may be fabricated from polypropylene, polyethylene or any other suitable bromine resistant material.

According to one embodiment, half-cell spacer screens may include at least two layers of strands. The strands within each layer are parallel to each other but are disposed at an angle with respect to neighboring layers. Strands within each layer may be oriented perpendicular to each other or at another angle that is more optimal for the electrolyte mixing and/or flow. Furthermore, mesh within half-cell spacer screens may be orientated in battery cell in order that first layer strands and second layer strands are at equal angles with respect to electrolyte flow direction. In one embodiment, the angle for both first layer strands and second layer strands may be of about 45 degrees to the electrolyte flow direction. Therefore, one embodiment of half-cell spacer screens may exhibit a diamond-like pattern mesh when viewed with a vertical electrolyte flow direction.

In one embodiment, the half-cell spacer design may use a bi-axially oriented netting which may be stretched in both directions under controlled conditions in order to produce strong, flexible, light weight netting.

The disclosed half-cell spacer screens may provide a better electrolyte flow distribution throughout electrode sheets, avoiding stagnant regions on the sides of the electrode sheets or in other regions here the cell may collapse, subsequently improving battery performance. Flow tests performed to prior art flow batteries and to flow batteries that include the disclosed half-cell spacer screens show that the half-cell spacer screens may improve distribution of the bromine electrolyte throughout the active surface of the electrode sheet. Additionally, flow battery performance testing also shows that the disclosed half-cell spacer screens may significantly improve current distribution between cell stacks which in turn may provide improved energy efficiency.

### LIST OF FIGURES

Embodiments of the present invention are described by way of example with reference to the accompanying figures, which are schematic and are not intended to be drawn to scale.

FIG. 1 illustrates flow battery cell that includes the disclosed half-cell spacer screens, according to an embodiment.

FIG. 2 illustrates a half-cell spacer screen in a diamond-like pattern mesh configuration, according to an embodiment.

FIG. 3 illustrates a half-cell spacer screen that includes a squared-grid pattern mesh configuration, according to an embodiment.

FIG. 4 illustrates a half-cell spacer screen that includes a four-layer pattern mesh configuration, according to an embodiment.

FIG. 5 illustrates flow tests results of a prior art zinc-bromine flow battery.

FIG. 6 illustrates flow tests results of a zinc-bromine flow battery that includes one embodiment of the disclosed half-cell spacer.

### DETAILED DESCRIPTION

The present disclosure is here described in detail with reference to embodiments illustrated in the drawings, which form a part here. In the drawings, which are not necessarily to scale or to proportion, similar symbols typically identify similar components, unless context dictates otherwise. Other embodiments may be used and/or and other changes may be made without departing from the spirit or scope of the present disclosure. The illustrative embodiments described in the detailed description are not meant to be limiting of the subject matter presented here.

### Definitions

As used herein, “battery cell” may refer to an enclosure provided with at least a pair of electrodes and at least one inlet and one outlet configured to allow the flow of electrolyte through the enclosure.

As used herein, “flow battery” or “flowing electrolyte battery” may refer to an electrochemical device that includes at least one battery cell stack and is capable of storing energy.

As used herein, “electrode” may refer to at least one polymeric material that has the ability of transferring electrical charge and thus exhibits electrical conductivity.

As used herein, “mesh” may refer to at least one screen or a net-like structure that may include open spaces as well as strands, cords, wires or threads that surround the open spaces.

### Description of Drawings

Disclosed here is a mechanism for enhancing the distribution of electrolyte flow within a battery cell by employing at least one half-cell spacer screen and subsequently improving the performance of flow battery systems. Embodiments in this disclosure may be applicable to flow batteries that incorporate the plating of a metal to store energy, such as: ZnBr, ZnCl, ZnHBr, ZnFe, CeZn, among others.

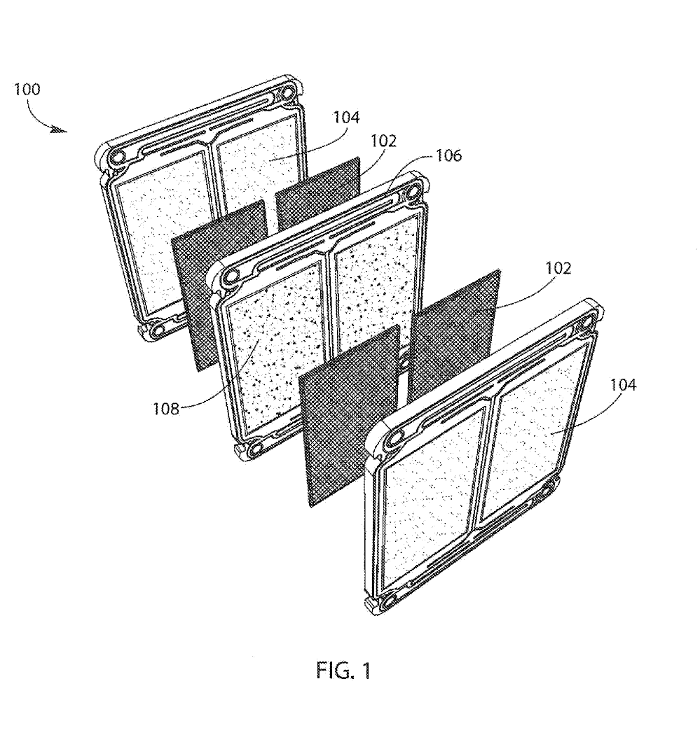

FIG. 1 depicts one embodiment of a flow battery cell 100 that includes the disclosed half-cell spacer 102 screens. Flow battery cell 100 may include electrode sheets 104, flow frame 106, half-cell spacer 102 screens and micro-porous separators 108, where half-cell spacer 102 screen ay be welded across at least one surface of electrode sheets 104 in order to allow an evenly distributed electrolyte flow throughout electrode sheets 104. Even distribution of electrolyte stream may ensure uniform current flow throughout electrodes 104 and may allow the production of highly conductive flow battery cell 100.

Furthermore, the disclosed half-cell spacer 102 screens may prevent electrode sheets 104 from getting in contact with micro-porous separators 108. Additionally, half-cell spacer 102 screens may help maintain a constant gap thickness between electrode sheets 104 and micro-porous separators 108, and ay avoid stagnant regions on the sides of electrode sheets 104; subsequently allowing a constant electrolyte flow through electrodes 104 within battery cells. Furthermore, half-cell spacer 102 screens may also prevent zinc dendrites and other plating irregularities that may be formed on electrode sheets 104. The prevention of zinc dendrite growth may not only enhance flow battery performance but also increase operating lifetime of flow batteries.

Additionally, half-cell spacer 102 screens may have positive effects on the turbidity of the electrolyte flow which may induce the dispersal of the aqueous and oily electrolyte phases, enhancing chemical availability and ionic conductivity within the flow battery cells. In some embodiments, structures for directing turbulent electrolyte into the cell flow may be included in electrolyte fluid circuit immediately prior to entering the battery cell. The high mixing flow may be useful during both charging and discharging processes.

In some embodiments, half-cell spacer 102 screens may include one or more layers of structures such as: strands, threads, wires, tubes or the like that may exhibit different suitable patterns. Additionally, structures of each layer may be straight or curved and may exhibit different dimensions. These surfaces may be aerodynamic to reduce flow resistance and/or have an increased surface area to retain the Bromine phase for chemical availability. To improve the Bromine retention the space material may contain or be coated with attracting agents.

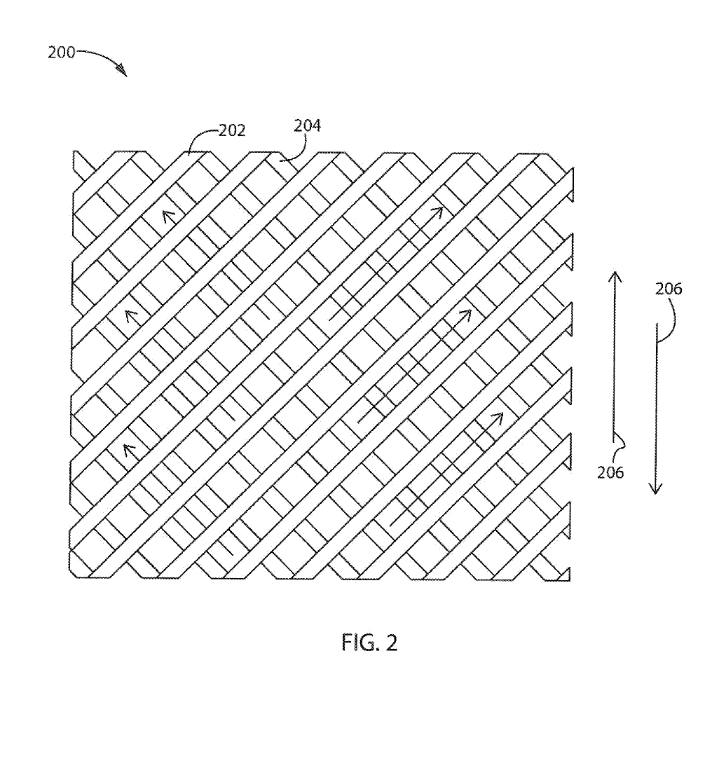

FIG. 2 illustrates one embodiment of half-cell spacer 102 screen in a diamond-like pattern mesh 200 configuration, in which half-cell spacer 102 screen may be bi-planar and may improve flow battery performances.

According to one embodiment, half-cell spacer 102 screens may include two layers of parallel straight strands, in which first layer strands 202 may be disposed at angles with respect to second layer strands 204. Angles between first layer strands 202 and second layer strands 204 may be of about 90 degrees in order that first layer strands 202 may be oriented perpendicular to second layer strands 204. Additionally, half-cell spacer 102 screens may be orientated in the battery cell such that the first layer strands 202 and second layer strands 204 are at equal angles with respect to electrolyte flow direction 206, whereby preferred angle may be of about 45 degrees to electrolyte flow direction or any other suitable angle.

First layer strands 202 and second layer strands 204 within half-cell spacer 102 screens may exhibit suitable dimensions depending on the specifications needed for the flow batteries. First layer strands 202 and second layer strands 204 may be 0.35 mm to about 0.5 mm in diameter, preferably being 0.45 mm in diameter, resulting in a screen thickness between and 0.75 mm to 1.0 mm, preferably being 0.9 mm thick. Spacing between each strand in the first 202 and second layers 204 may be between about 4.0 mm and 10 mm, preferably being about 6 mm.

Additionally, suitable dimensions for half-cell spacer 102 screens may be according to electrode 104 sheet dimensions in which half-cell spacer 102 screens may be attached to. In one embodiment, half-cell spacer 102 may exhibit a rectangular shape; in other embodiments, half-cell spacer 102 may exhibit a squared shape, oval, circular shape or any other suitable shape depending on the cell shape and the shape of the electrode sheets 104 where the half-cell spacer 102 screens may be welded to.

Suitable thermoplastic bromine inert material for the manufacture of half-cell spacer 102 screens may include one or more polymers selected from polyethylene, polypropylene and copolymer blends of ethylene and propylene, acetyl, nylons, polystyrene, polyethylene terephthalate, polyvinylidene fluoride, polyvinyl chloride, polytetrafluoroethylene, fluorinated ethylene-propylene copolymer, polyfluoramide or chlorinated polyoxymethylene, among others.

In one embodiment, half-cell spacer 102 screens may be ultrasonically welded over at least one surface of the electrode sheets 104 before assembling these electrodes 104 into to flow battery stacks 100. In order to weld half-cell spacer 102 screens onto electrode 104, an ultrasonic welding tool may be employed. This process uses an ultrasonic vibration to melt and intermix the spacer and flow frame materials. Welding should be performed in temperatures between about 20° C. to 30° C., for optimal results. Half-cell spacer 102 screens may include strong, flexible, light weight netting that may be easily ultrasonically welded over electrode sheet 104.

Additionally, crossing pattern within half-cell spacer 102 screens may help distribute electrolyte flow better and induce the mixing of aqueous and oily electrolyte phases on at least one surface of electrode sheet 104.

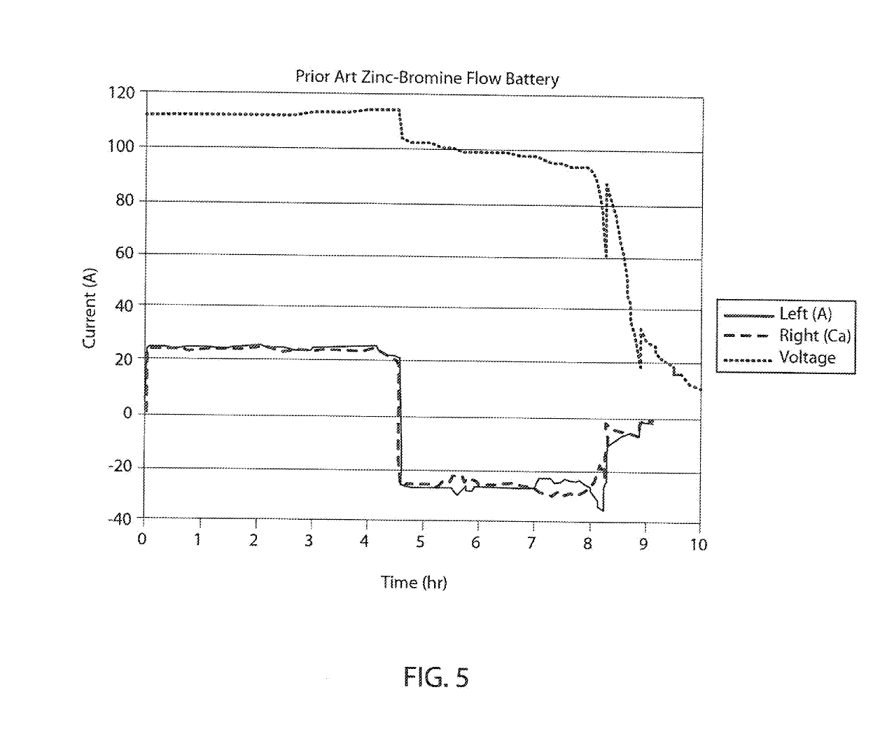

FIG. 5: shows flow tests results performed to prior art zinc-bromine flow batteries.

FIG. 5 shows current and voltage behavior as functions of time. The current is divided into two halves, being taken from the parallel cells within the stack 100. The first one (left (A)) represents the current measured from the left side of the stack, which is the anolyte-port-inlet side. The second one (right (Ca)) represents the current taken from the right side of the stack, which is the catholyte-port-inlet side of the flow battery cell 100.

in FIG. 5, from hour about 5 to about hour 9, the uneven current flow across the two halves of flow battery cell 100 can be observed. Generally this current difference may be caused by an uneven distribution of electrolyte or Zinc plating across electrodes 104 within half cells, which may affect the rate at which the reactions occur. Uneven distribution of electrolytes may cause instability in the flow battery cells 100 and affects flow battery's performance.

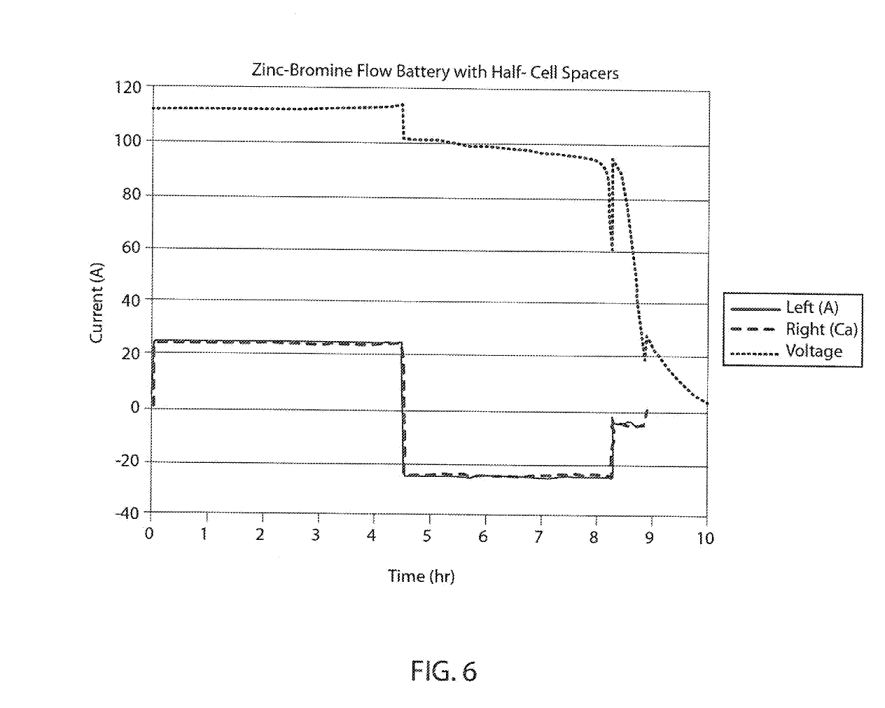

FIG. 6: shows flow tests results performed to zinc-bromine flow battery that includes the disclosed half-cell spacer 102 screens.

FIG. 6 shows current and voltage behavior as functions of time. The current is divided into two halves, the first one (left (A)) represents the current measured across the anolyte flow port half of flow battery cell 100 and the second one (right (Ca)) represents the current across the catholyte flow port half of flow battery cell 100.

In FIG. 6, from about hour 5 to about hour 9, even current flow across the two halves of flow batter cells 100 can be observed. Generally, the even current flow may be caused by uniform distribution of electrolytes across electrodes 104 within half cells, which may affect the rate at which the reactions occur.

FIG. 5 shows that batteries without the disclosed half-cell spacer 102 are subject to variations in the electrical current between the battery stack's internal parallel cells. This may also indicate wider variation of Zinc plating and reaction potentials within the individual cells 100. Moreover, FIG. 6, in which disclosed half-cell spacer 102 screens are employed within flow battery cells 100, shows that electrical current within the stack may be evenly distributed between the battery's internal parallel cells. As shown in both graphs, electrical current on each side of the flow battery parallel cells 100, was evenly distributed almost perfectly into the battery's two halves when disclosed half-cell spacer 102 is employed; consequently results show that there is a more consistent electrolyte flow on both sides of flow battery cells 100.

As shown in FIG. 6, the disclosed half-cell spacer 102 screens may help improve the distribution of the bromine electrolyte throughout surface of electrode sheet 104, within zinc bromine batteries. Furthermore, battery performance testing results also show that half-cell spacer 102 screens may significantly improve current distribution between the flow battery cells 100 which in turn may provide improved energy efficiency and longevity.

Table 1 depicts summary of performance tests results performed to flow batteries that include the disclosed half-cell spacer 102 screens. As shown in table 1, the flow battery including half-cell spacer 102 screens would generally exhibit a power output of 18.45 kWh, compared to 18.06 kWh that prior art flow battery exhibits. The energy efficiency of the flow battery may also be improved by employing half-cell spacer 102 screens, which would generally exhibit an energy efficiency of 72.4%, while prior art flow batteries depict an energy efficiency of 71%. Similarly, since prior art flow battery exhibit a voltaic efficiency of 86.5%, the results show that voltaic efficiency of a flow battery may also be increased by employing the depicted half-cell spacer 102 screens.

TABLE 1

| Parameters | Prior Art | With Half-Cell Spacer |
|---|---|---|
| kWh output | 18.06 kWh | 18.45 kWh |
| Coulombic Efficiency | 82.0% | 83.2% |
| Voltaic Efficiency | 86.5% | 87.0% |
| Energy Efficiency | 71.0% | 72.4% |

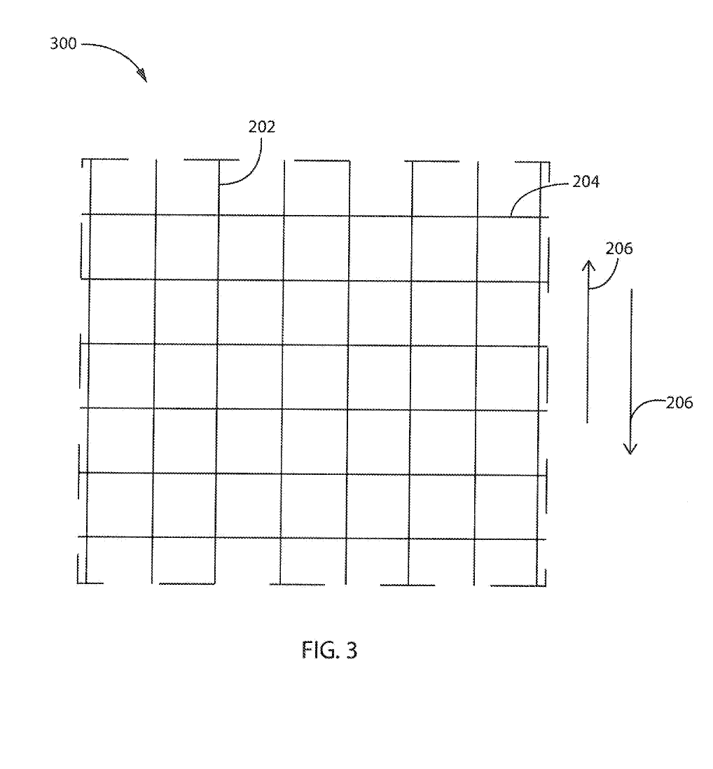

FIG. 3 illustrates a half-cell spacer 102 screen that includes a squared-grid pattern mesh 300 configuration, according to an embodiment.

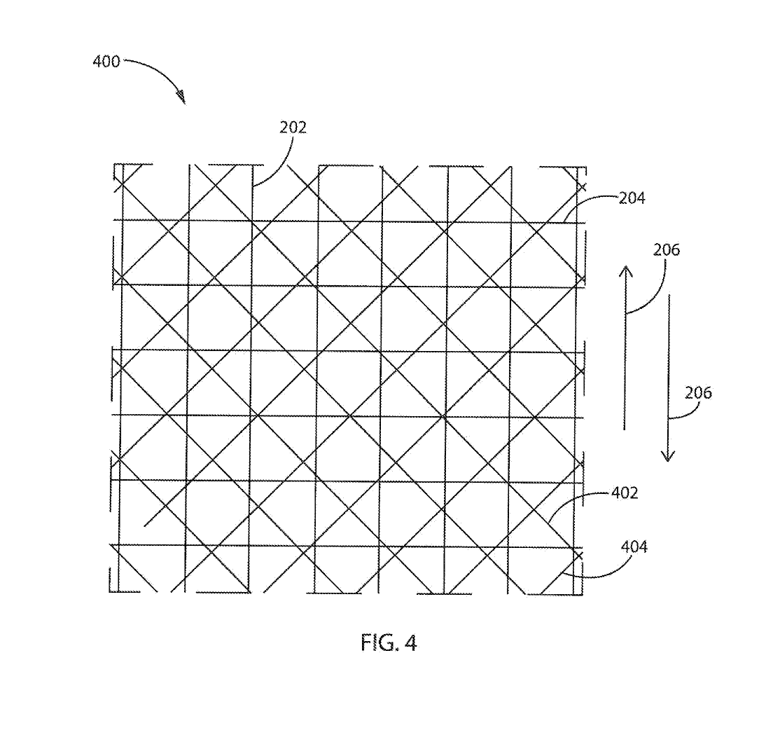

FIG. 4 illustrates a half-cell spacer 102 screen that includes a four-layer pattern mesh 400 configuration, according to an embodiment.

### EXAMPLES

### Example #1

is one embodiment of half-cell spacer 102 screens, where as shown in FIG. 3, half-cell spacer 102 screens, in a squared-grid pattern mesh 300 configuration, may be welded onto a flow battery electrode 104. Half-cell spacer 102 screens in squared-grid pattern mesh 300 configuration may include two layers of parallel strands in which the first layer of strands 202 may be parallel to the electrolyte flow direction 206 and the second layer of strands 204 may be perpendicular to both the first layer 202 and the electrolyte flow direction 206. Additionally, first layer strands 202 may be oriented perpendicular to second layer strands 204.

### Example #2

is one embodiment of half-cell spacer 102 screens, where as shown in FIG. 4, half-cell spacer 102 screens in a four-layer pattern mesh 400 configuration may be welded onto a flow battery electrode 104. Half-cell spacer 102 screens in four-layer pattern mesh 400 configuration may include at least four layers of strands where first layer strands 202 may go in the same direction of electrolyte flow direction 206, second layer strands 204 may be perpendicularly oriented to electrolyte flow direction 206, third layer strands 402 may go in a 45 degrees angle orientation to electrolyte flow direction 205, and fourth layer strands 404 may also go in a 45 degrees angle orientation to electrolyte flow direction 206. Moreover, third layer strands 402 may be oriented perpendicular to fourth layer strands 404, and first layer strands 202 may also be oriented perpendicular to second layer strands 204.

### Example #3

is one embodiment of a flow battery cell 100, where the half-cell spacer 102 screens may be employed in a flowing-electrolyte fuel cell system. Half-cell spacer 102 screens may be welded or bonded to both positive electrode 104 and to negative electrode 104 within fuel cell before positive electrode 104 and negative electrode 104 are integrated in the fuel cell. By employing half-cell spacer 102 screens, electrolyte distribution within fuel cell may be improved, subsequently enhancing fuel cell performance.

We claim:

1. A spacer screen for use in conjunction with an electrode for a electrolyte flow battery cell to direct the flow of electrolyte over the electrode, the spacer screen comprising:
a. a first layer of material stands oriented parallel to one another and extending in a first direction; and
b. a second layer of material strands secured to the first layer, the second layers of strands oriented parallel to one another and extending in a second direction, wherein the second direction is at an angle with respect to the first direction.

2. The spacer screen of claim 1 wherein the second direction is perpendicular to the first direction.

3. The spacer screen of claim 1 wherein the first direction is at an angle of 45° relative to a direction of electrolyte flow across the electrode.

4. The spacer screen of claim 1 wherein the first direction and the second direction are at angles that are equal but opposite to one another.

5. The spacer screen of claim 1 wherein at least one of the first layer or the second layer is formed from a bi-planar mesh.

6. The spacer screen of claim 5 wherein the bi-planar mesh is selected from the group consisting of polypropylene, polyethylene, and combinations thereof.

7. The spacer screen of claim 1 wherein at least one of the first layer or the second layer is formed of a bi-axially oriented netting.

8. The spacer screen of claim 1 wherein the material strands of at least one of the first layer or the second layer are straight.

9. The spacer screen of claim 1 wherein the material strands of at least one of the first layer or the second layer have an aerodynamic cross-section.

10. The spacer screen of claim 1 wherein the material strands of at least one of the first layer or the second layer have a non-aerodynamic cross-section.

11. The spacer screen of claim 1 wherein the material strands of at least one of the first layer or the second layer have a bromine-attracting agent applied thereto.

12. The spacer screen of claim 1 wherein the material strands of at least one of the first layer or the second layer are from about 0.35 mm to about 0.50 mm in diameter.

13. The spacer screen of claim 1 wherein the material strands of at least one of the first layer or the second layer are spaced from one another in their respective layers a distance of between about 4.0 mm to about 10.0 mm.

14. The spacer screen of claim 1 wherein the material strands of at least one of the first layer or the second layer are selected from the group consisting of strands, threads, wires, tubes, or combinations thereof.

15. A flow frame for an electrolyte flow battery cell, the flow frame comprising:
a. a body;
b. at least one electrode secured to the body; and
c. at least one spacer screen formed according to claim 1 secured to the electrode opposite the body.

16. A battery cell for an electrolyte flow battery stack, the cell comprising a number of flow frames formed according to claim 15 secured to one another to form the cell.
